(19) United States
(12) Patent Application Publication
(10) Pub. No.: US 2025/0372710 A1
(43) Pub. Date: Dec. 4, 2025

(54) ELECTROLYTE SOLUTION FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Nam-Soon CHOI, Daejeon (KR); Myunghoon KIM, Yongin-si (KR); Aeran KIM, Yongin-si (KR); Seunghee HAN, Daejeon (KR); ARUM YU, Yongin-si (KR); SANGHOON KIM, Yongin-si (KR); JUNYOUNG KIM, Daejeon (KR); Gihoon LEE, Daejeon (KR); Sewon PARK, Daejeon (KR)

(73) Assignee: Korea Advanced Institute of Science and Technology, Daejeon (KR)

(21) Appl. No.: 19/096,056

(22) Filed: Mar. 31, 2025

(30) Foreign Application Priority Data
May 31, 2024 (KR) 10-2024-0071399

(51) Int. Cl. H01M 10/0567; H01M 4/02; H01M 4/36; H01M 4/38; H01M 4/525; H01M 4/583; H01M 10/0525; H01M 10/0568; H01M 10/0569

(52) U.S. Cl. CPC H01M 10/0567; H01M 4/362; H01M 4/386; H01M 4/525; H01M 4/583; H01M 10/0525; H01M 10/0568; H01M 10/0569; H01M 2004/027; H01M 2004/028; H01M 2300/004

(57) ABSTRACT

Provided is an electrolyte solution for a rechargeable lithium battery and a rechargeable lithium battery including the same, and the electrolyte solution includes a non-aqueous organic solvent, a lithium salt, and an additive represented by Formula 1 as described herein.

### CROSS-REFERENCE TO RELATED APPLICATIONS

The present application claims priority to and the benefit of Korean Patent Application No. 10-2024-0071399, filed on May 31, 2024, in the Korean Intellectual Property Office, the entire content of which is hereby incorporated by reference.

### BACKGROUND

Embodiments of the present disclosure herein relate to an electrolyte solution for a rechargeable lithium battery, and a rechargeable lithium battery including the same.

Recently, with the rapid spread of battery-using electronic devices, such as mobile phones, laptop computers, and electric vehicles, interest in a rechargeable battery having high energy density and high capacity has been rapidly increased. Accordingly, research and development has been actively conducted to improve performance of the rechargeable lithium battery.

The rechargeable lithium battery may include a positive electrode and a negative electrode including an active material capable of intercalation and deintercalation of lithium ions, and an electrolyte solution. Electrical energy is produced by oxidation and reduction reactions if (e.g., when) the lithium ions are intercalated and deintercalated into/from the positive electrode and the negative electrode.

A solution in which a lithium salt is dissolved in a non-aqueous organic solvent may be used as an electrolyte for a rechargeable lithium battery. The rechargeable lithium battery has battery characteristics through complex reactions between the positive electrode and the electrolyte, the negative electrode and the electrolyte, and/or the like. Therefore, the use of a suitable or appropriate electrolyte is one variable that may improve performance of the rechargeable lithium battery.

### SUMMARY

Embodiments of the present disclosure provide an electrolyte solution for a rechargeable lithium battery having improved high-temperature lifespan characteristics and stability.

Embodiments of the present disclosure also provide a rechargeable lithium battery including the electrolyte solution.

An embodiment of the present disclosure provides an electrolyte solution for a rechargeable lithium battery including a non-aqueous organic solvent, a lithium salt, and an additive represented by Formula 1 below.

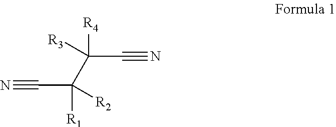

In Formula 1 above,

R₁ to R₄ is each independently selected from the group consisting of a halogen atom, a C1 to C20 alkyl group, a C1 to C20 halogenated alkyl group, a C3 to C30 cycloalkyl group, a C6 to C30 aryl group, a hydroxy group, a C1 to C10 alkoxy group, a carboxylic acid group, an aldehyde group, an epoxy group, a cyano group, a nitro group, an amino group, a sulfonic acid group, and a derivative thereof.

In an embodiment of the present disclosure, a rechargeable lithium battery includes a positive electrode including a positive electrode active material, a negative electrode including a negative electrode active material, and an electrolyte solution, and the electrolyte solution includes a non-aqueous organic solvent, a lithium salt, and the additive represented by Formula 1 according to embodiments of the present disclosure.

### BRIEF DESCRIPTION OF THE DRAWINGS

The accompanying drawings are included to provide a further understanding of the subject matter of the present disclosure, and are incorporated in and constitute a part of this specification. The drawings illustrate embodiments of the present disclosure and, together with the description, serve to explain principles of the present disclosure. In the drawings:

FIG. 1 is a simplified conceptual diagram illustrating a rechargeable lithium battery according to embodiments of the present disclosure; and

FIG. 2 is a cutaway perspective view illustrating a rechargeable lithium battery according to an embodiment.

FIG. 3 is a cross-sectional view schematically illustrating a rechargeable lithium battery according to an embodiment.

FIGS. 4-5 are perspective views illustrating a rechargeable lithium battery according to embodiments of the present disclosure.

### DETAILED DESCRIPTION

In order to fully understand the configuration and effect of the subject matter of the present disclosure, embodiments of the present disclosure will be described below in more detail with reference to the accompanying drawings. The subject matter of the present disclosure may, however, be embodied in various suitable forms and should not be construed as limited to the embodiments set forth herein, and various suitable changes and modifications can be made. Rather, these embodiments are provided so that this disclosure will be thorough and complete, and will fully convey the scope of the present disclosure to those skilled in the art to which the present disclosure pertains.

In this specification, it will be understood that, if (e.g., when) an element is referred to as being on another element, the element may be directly on the other element or intervening elements may be present therebetween. In the drawings, thicknesses of components may be exaggerated to effectively explain the technical contents. Like reference numerals or symbols refer to like elements throughout the specification.

The singular forms are intended to include the plural forms as well, unless the context clearly indicates otherwise. In embodiments, unless otherwise specially noted, the phrase “A or B” may indicate “A but not B”, “B but not A”, or “A and B”. The terms “comprises/includes” and/or “comprising/including” used in this description do not exclude the presence or addition of one or more other components.

In this specification, “combination thereof” may refer to a mixture, a stack, a composite, a copolymer, an alloy, a blend, and/or a reaction product of components.

In this specification, unless otherwise defined, “substitution” means that at least one hydrogen of a substituent and/or a compound is substituted with deuterium, a halogen group, a hydroxyl group, an amino group, a C1 to C30 amine group, a nitro group, a C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C20 alkoxy group, a C1 to C10 fluoroalkyl group, a cyano group, or a combination thereof.

In embodiments, “substituted” may mean that at least one hydrogen of a substituent or a compound is substituted with deuterium, a halogen group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, and/or a cyano group. For example, “substituted” may mean that at least one hydrogen of a substituent and/or a compound is substituted with deuterium, a halogen group, a C1 to C20 alkyl group, a C6 to C30 aryl group, a C1 to C10 fluoroalkyl group, and/or a cyano group. In embodiments, “substituted” may mean that at least one hydrogen of a substituent and/or a compound is substituted with deuterium, a halogen group, a C1 to C5 alkyl group, a C6 to C18 aryl group, a C1 to C5 fluoroalkyl group, and/or a cyano group. For example, “substituted” may mean that at least one hydrogen of a substituent and/or a compound is substituted with deuterium, a cyano group, a halogen group, a methyl group, an ethyl group, a propyl group, a butyl group, a phenyl group, a biphenyl group, a terphenyl group, a trifluoromethyl group, and/or a naphthyl group.

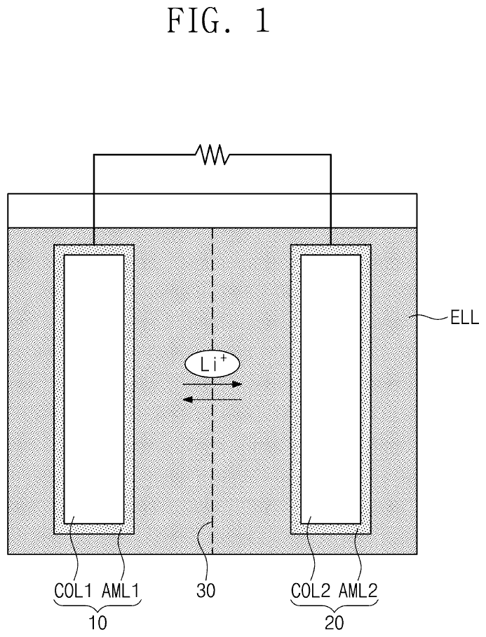

FIG. 1 is a cross-sectional view of a rechargeable lithium battery according to embodiments of the present disclosure. Referring to FIG. 1, the rechargeable lithium battery may include a positive electrode 10, a negative electrode 20, a separator 30, and an electrolyte solution ELL.

The positive electrode 10 and the negative electrode 20 may be spaced apart from each other by the separator 30. The separator 30 may be between the positive electrode 10 and the negative electrode 20. The positive electrode 10, the negative electrode 20 and the separator 30 may be in contact with the electrolyte solution ELL. The positive electrode 10, the negative electrode 20 and the separator may be impregnated with the electrolyte solution ELL.

The electrolyte solution ELL may be a medium that transfers lithium ions between the positive electrode 10 and the negative electrode 20. In the electrolyte solution ELL, the lithium ions may move through the separator 30 toward the positive electrode 10 or the negative electrode 20.

### Positive Electrode 10

The positive electrode 10 for a rechargeable lithium battery may include a current collector COL1 and a positive electrode active material layer AML1 on the current collector. The positive electrode active material layer AML1 may include a positive electrode active material and may further include a binder and/or a conductive material (e.g., an electrically conductive material).

For example, the positive electrode 10 may further include an additive that can serve as a sacrificial positive electrode.

An amount of the positive electrode active material may be about 90 wt % to about 99.5 wt % based on 100 wt % of the positive electrode active material layer AML1. Amounts of the binder and the conductive material may be about 0.5 wt % to about 5 wt %, respectively, based on 100 wt % of the positive electrode active material layer AML1.

The binder serves to attach the positive electrode active material particles well to each other and also to attach the positive electrode active material well to the current collector COL1. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may be used to impart conductivity(e.g., electrical conductivity) to the electrode. Any suitable material that does not cause a chemical change (e.g., does not cause an undesirable chemical change in the rechargeable lithium battery) and conducts electrons can be used in the battery. Examples of the conductive material may include a carbon-based material such as natural graphite, artificial graphite, carbon black, acetylene black, ketjen black, a carbon fiber, a carbon nanofiber, and carbon nanotube; a metal-based material containing copper, nickel, aluminum, silver, and/or the like, in a form of a metal powder and/or a metal fiber; a conductive polymer (e.g., an electrically conductive polymer) such as a polyphenylene derivative; or a mixture thereof.

Al may be used as the current collector COL1, but the current collector COL1 is not limited thereto.

### Positive Electrode Active Material

The positive electrode active material may include a compound (e.g., a lithiated intercalation compound) that is capable of intercalating and deintercalating lithium. For example, at least one of a composite oxide of lithium and a metal selected from among cobalt, manganese, nickel, and combinations thereof may be used.

The composite oxide may be a lithium transition metal composite oxide. Examples of the composite oxide may include lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one selected from among the following Chemical Formulas may be used. LiₐA_{1-b}X_{b}O_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}Co_{b}X_{c}O_{2-α}D_{α} (0.90≤a≤1.8, 0≤b≤0.5, 0≤c≤0.5, and 0<α<2); LiₐNi_{1-b-c}Mn_{b}X_{c}O_{2-α}D_{α} (0.90≤a≤1.8, 0≤b≤0.5, 0≤c≤0.5, and 0<α<2); LiₐNi_{b}Co_{c}L¹_{d}GₑO₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃(0≤f≤2); or LiₐFePO₄(0.90≤a≤1.8).

In the above Chemical Formulas, A is Ni, Co, Mn, or a combination thereof; X is Al, Ni, Co, Mn, Cr, Fe, Mg, Sr, V, a rare earth element or a combination thereof; D is 0, F, S, P, or a combination thereof; G is Al, Cr, Mn, Fe, Mg, La, Ce, Sr, V, or a combination thereof; and L¹ is Mn, Al, or a combination thereof.

The positive electrode active material may be, for example, a high nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing high capacity and can be applied to a high-capacity, high-density rechargeable lithium battery.

### Negative Electrode 20

The negative electrode 20 for a rechargeable lithium battery may include a current collector COL2 and a negative electrode active material layer AML2 on the current collector COL2. The negative electrode active material layer AML2 may include a negative electrode active material, and may further include a binder and/or a conductive material (e.g., an electrically conductive material).

For example, the negative electrode active material layer AML2 may include about 90 wt % to about 99 wt % of the negative electrode active material, about 0.5 wt % to about 5 wt % of the binder, and about 0 wt % to about 5 wt % of the conductive material.

The binder may serve to attach the negative electrode active material particles well to each other and also to attach the negative electrode active material well to the current collector COL2. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be selected from among a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

If (e.g., when) an aqueous binder is used as the negative electrode binder, a cellulose-based compound capable of imparting or increasing viscosity may be further included. The cellulose-based compound may include at least one of carboxymethyl cellulose, hydroxypropylmethyl cellulose, methyl cellulose, or an alkali metal salt thereof. The alkali metal may include Na, K, and/or Li.

The dry binder may be a polymer material that is capable of being fibrous (e.g., capable of being fiberized). For example, the dry binder may be polytetrafluoroethylene, polyvinylidene fluoride, a polyvinylidene fluoride-hexafluoropropylene copolymer, polyethylene oxide, or a combination thereof.

The conductive material may be used to impart conductivity (e.g., electrical conductivity) to the electrode. Any suitable material that does not cause a chemical change (e.g., does not cause an undesirable chemical change in the rechargeable lithium battery) and that conducts electrons can be used in the battery. Non-limiting examples thereof may include a carbon-based material such as natural graphite, artificial graphite, carbon black, acetylene black, ketjen black, a carbon fiber, a carbon nanofiber, and a carbon nanotube; a metal-based material including copper, nickel, aluminum, silver, and/or the like in a form of a metal powder and/or a metal fiber; a conductive polymer (e.g., an electrically conductive polymer) such as a polyphenylene derivative; or a mixture thereof.

The negative current collector COL2 may include a copper foil, a nickel foil, a stainless steel foil, a titanium foil, a nickel foam, a copper foam, a polymer substrate coated with a conductive metal, or a combination thereof.

### Negative Electrode Active Material

The negative electrode active material may include a material that reversibly intercalates/deintercalates lithium ions, a lithium metal, a lithium metal alloy, a material capable of doping/dedoping lithium, and/or a transition metal oxide.

The material that reversibly intercalates/deintercalates lithium ions may include a carbon-based negative electrode active material, such as, for example. crystalline carbon, amorphous carbon or a combination thereof. The crystalline carbon may be graphite such as non-shaped, sheet-shaped, flake-shaped, sphere-shaped, and/or fiber-shaped natural graphite and/or artificial graphite. The amorphous carbon may be a soft carbon, a hard carbon, a mesophase pitch carbonization product, calcined coke, and/or the like.

The lithium metal alloy includes an alloy of lithium and a metal selected from among Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material and/or a Sn-based negative electrode active material. The Si-based negative electrode active material may include silicon, a silicon-carbon composite, SiOx(0≤x≤2), a Si-Q alloy (where Q is selected from among an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include Sn, SnO₂, a Sn-based alloy, or a combination thereof.

The silicon-carbon composite may be a composite of silicon and amorphous carbon. According to an embodiment, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material and/or the Sn-based negative electrode active material may be used in combination with a carbon-based negative electrode active material.

### Separator 30

Depending on the type (or kind) of the rechargeable lithium battery, the separator 30 may be present between the positive electrode 10 and the negative electrode 20. The separator 30 may include polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and/or the like.

The separator 30 may include a porous substrate and a coating layer including an organic material, an inorganic material, or a combination thereof on one or both surfaces (e.g., two opposing surfaces) of the porous substrate.

The porous substrate may be a polymer film formed of any one selected from among polymer polyolefin such as polyethylene and/or polypropylene, polyester such as polyethylene terephthalate and/or polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and/or polytetrafluoroethylene, and/or a copolymer and/or mixture of two or more thereof.

The organic material may include a polyvinylidene fluoride-based polymer and/or a (meth)acrylic polymer.

The inorganic material may include inorganic particles selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but the inorganic material is not limited thereto.

The organic material and the inorganic material may be mixed in one coating layer, or a coating layer including an organic material and a coating layer including an inorganic material may be stacked.

### Electrolyte Solution ELL

The electrolyte solution ELL for a rechargeable lithium battery may include a non-aqueous organic solvent and a lithium salt.

The non-aqueous organic solvent may serve as a medium that transmits ions taking part in the electrochemical reaction of a battery.

The non-aqueous organic solvent may be a carbonate-based, ester-based, ether-based, ketone-based, and/or alcohol-based solvent, an aprotic solvent, or a combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like.

The ester-based solvent may include methyl acetate, ethyl acetate, n-propyl acetate, dimethyl acetate, methyl propionate, ethyl propionate, decanolide, mevalonolactone, valerolactone, caprolactone, and/or the like.

The ether-based solvent may include dibutyl ether, tetraglyme, diglyme, dimethoxyethane, 2-methyltetrahydrofuran, 2,5-dimethyltetrahydrofuran, tetrahydrofuran, and/or the like. In embodiments, the ketone-based solvent may include cyclohexanone, and/or the like. The alcohol-based solvent may include ethanol, isopropyl alcohol, and/or the like and the aprotic solvent may include nitriles such as R—CN (wherein R is a C2 to C20 linear, branched, or cyclic hydrocarbon group, a double bond, an aromatic ring, and/or an ether bond, and/or the like; amides such as dimethylformamide; dioxolanes such as 1,3-dioxolane, 1,4-dioxolane, and/or the like; sulfolanes, and/or the like.

The non-aqueous organic solvents may be used alone or in combination of two or more.

In embodiments, if (e.g., when) using a carbonate-based solvent, a cyclic carbonate and a chain carbonate may be mixed and used, and the cyclic carbonate and the chain carbonate may be mixed in a volume ratio of about 1:1 to about 1:9.

The lithium salt dissolved in the organic solvent supplies lithium ions in a battery, enables a basic operation of a rechargeable lithium battery, and improves transportation of the lithium ions between positive and negative electrodes. Examples of the lithium salt include at least one selected from among LiPF₆, LiBF₄, LiSbF₆, LiAsF₆, LiCIO₄, LiAIO₂, LiAICl₄, LiPO₂F₂, LiCl, Lil, LiN(SO₃C₂F₅)₂, Li(FSO₂)₂N (lithium bis(fluorosulfonyl)imide, LiFSl), LiC₄F₉SO₃, LiN(CₓF₂ₓ₊₁SO₂)(C_{y}F_{2y+1}SO₂) (wherein x and y are integers of 1 to 20), lithium trifluoromethane sulfonate, lithium tetrafluoroethanesulfonate, lithium difluoro(oxalato)borate (LiDFOB), lithium difluorobis(oxalato)phosphate (LiDFBOP), and lithium bis(oxalato) borate (LiBOB).

### Rechargeable Lithium Battery

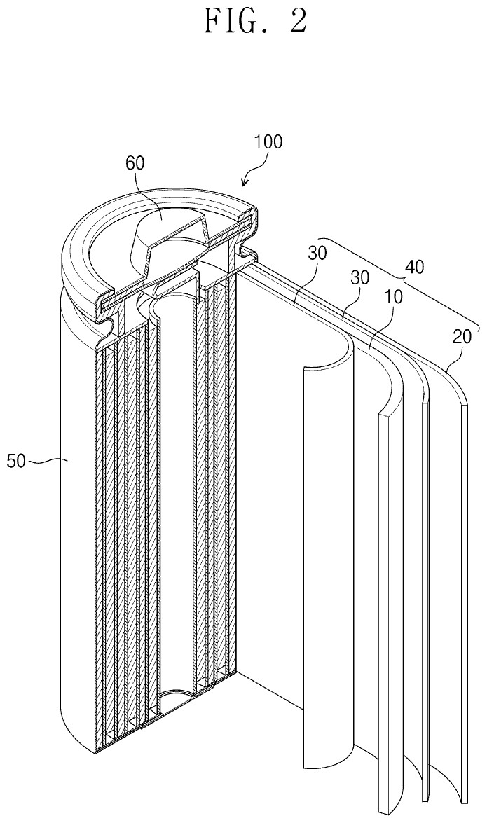

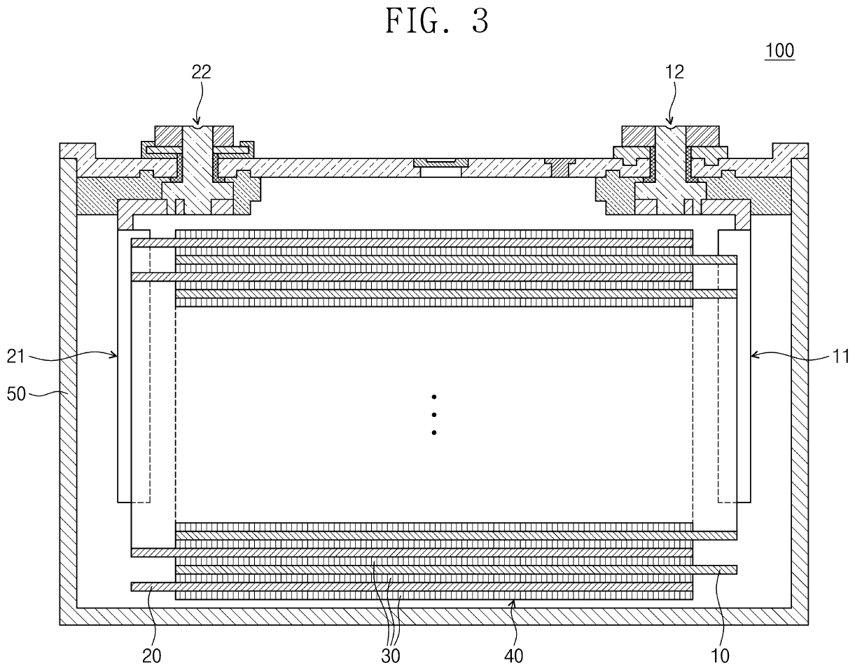

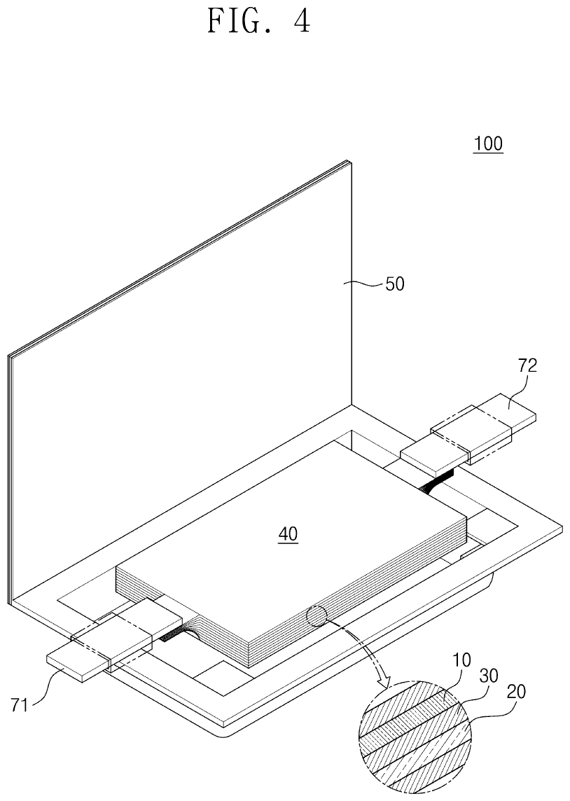

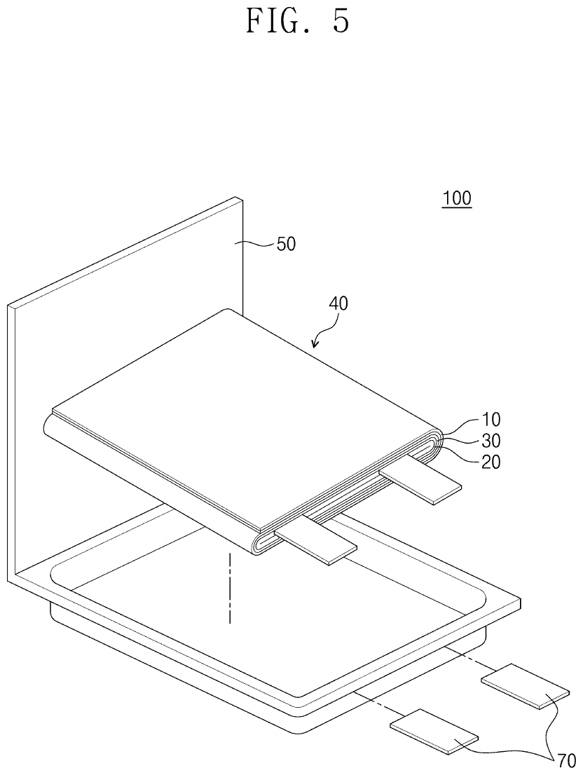

The rechargeable lithium battery may be classified into cylindrical, prismatic, pouch, or coin-type batteries, and/or the like depending on their shape. FIGS. 2 to 5 are schematic views illustrating a rechargeable lithium battery according to an embodiment. FIG. 2 shows a cylindrical battery, FIG. 3 shows a prismatic battery, and FIGS. 4 and 5 show pouch-type batteries. Referring to FIGS. 2 to 5, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte solution. The rechargeable lithium battery 100 may include a sealing member 60 that seals the case 50, as shown in FIG. 2. In FIG. 3, the rechargeable lithium battery 100 may include a positive lead tab 11, a positive terminal 12, a negative lead tab 21, and a negative terminal 22. As shown in FIGS. 4 and 5, the rechargeable lithium battery 100 may include an electrode tab 70 (FIG. 5), which may be, for example, a positive electrode tab 71 and a negative electrode tab 72 (FIG. 4) that serve as an electrical path to induce the current formed in the electrode assembly 40 to the outside.

Hereinafter, an electrolyte solution for a rechargeable lithium battery according to embodiments of the present disclosure will be described in more detail.

The electrolyte solution for a rechargeable lithium battery, according to an embodiment, includes a non-aqueous organic solvent, a lithium salt, and an additive.

The additive according to an embodiment of the present disclosure may be represented by Formula 1 below.

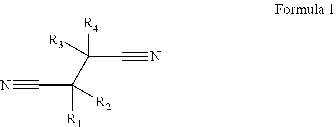

In Formula 1 above,
R₁ to R₄ may be each independently selected from the group consisting of a halogen atom, a C1 to C20 alkyl group, a C1 to C20 halogenated alkyl group, a C3 to C30 cycloalkyl group, a C6 to C30 aryl group, a hydroxy group, a C1 to C10 alkoxy group, a carboxylic acid group, an aldehyde group, an epoxy group, a cyano group, a nitro group, an amino group, a sulfonic acid group, and a derivative thereof.

For the additive according to an embodiment of the present disclosure, in Formula 1 above, R₁ to R₄ may be each independently any one selected from among a methyl group, an ethyl group, a phenyl group, and a carboxyl group.

The additive may have a structure in which the same functional group is substituted for all R₁ to R₄, or a structure in which different functional groups are substituted. For example, the additive represented by Formula 1 above may be represented by Formula 1-1 to Formula 1-3.

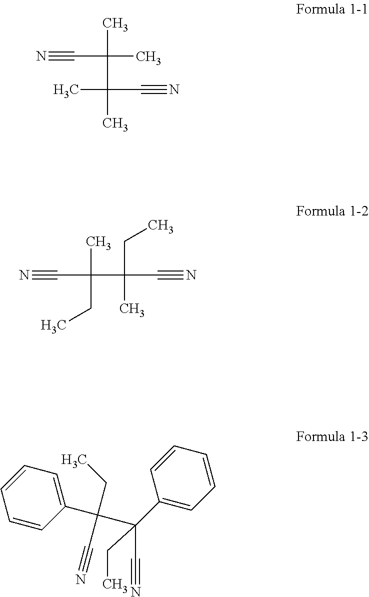

In Formula 1 above, at least one selected from among R₁ to R₄ may be a substituent including fluorine (e.g., a fluorine containing group such as, for example, a trifluoromethyl group) or a fluorine atom.

The additive according to an embodiment of the present disclosure may have a structure in which the substituent is partially or entirely fluorinated. For example, the additive represented by Formula 1 above may be a compound represented by Formula 1A-1 to Formula 1A-4 below.

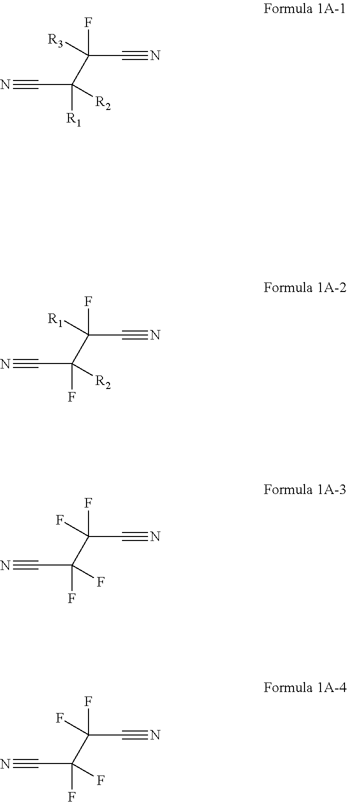

In Formula 1A-1 to Formula 1A-4 above,
R₁ to R₃ may be each independently selected from the group consisting of a C1 to C20 alkyl group, a C1 to C20 halogenated alkyl group, a C3 to C30 cycloalkyl group, a C6 to C30 aryl group, a hydroxy group, a C1 to C10 alkoxy group, a carboxylic acid group, an aldehyde group, an epoxy group, a cyano group, a nitro group, an amino group, a sulfonic acid group, and a derivative thereof.

The additive according to an embodiment of the present disclosure may be a compound having a linear structure including a plurality of nitrile functional groups.

With strong negative charge characteristics, the nitrile functional group may absorb or adsorb onto the surface of the positive electrode and form charge neutrality of a transition metal such as Ni⁴⁺ and Ni³⁺ (e.g., the nitrile functional group may provide a counterion to form a charge neutral complex), thereby suppressing or reducing a side reaction where an electrolyte solution (e.g., a solvent) decomposes.

The additive according to an embodiment of the present disclosure has a structure in which a carbon atom that connects two nitrile functional groups is substituted with a functional group effective in suppressing or reducing transition metal elution.

Because the additive represented by Formula 1 above has a structure in which R₁ to R₄ are all substituted with functional groups, a film may be formed on the surface of the positive electrode and decomposition of a positive electrode active material may thus be suppressed or reduced, thereby suppressing or reducing gas generation and transition metal elution caused by the decomposition of the positive electrode active material.

Accordingly, due to the structure in Formula 1 of embodiments of the present disclosure, the additive according to an embodiment of the present disclosure may contribute more effectively to high-voltage stability and cycle lifespan characteristics of a lithium battery.

The additive may be included in an amount of about 0.01 wt % to about 10 wt % with respect to the total amount of the electrolyte solution. In embodiments, the amount of the additive may be about 0.05 wt % to about 3 wt % with respect to the total amount of the electrolyte solution. If (e.g., when) the amount of the additive is below the above-mentioned range, a disadvantage in that films may not be formed suitably or sufficiently on a lithium-based positive electrode and negative electrode may be caused, and if (e.g., when) the amount of the additive exceeds the above-mentioned range, a disadvantage in that the battery capacity and lifespan decrease, due to an increase in resistance (e.g., electrical resistance) of the positive electrode and the negative electrode, may be caused.

Effects of embodiments of the additive, represented by Formula 1 above, on improving high-temperature stability of the rechargeable lithium battery are more noticeable if (e.g., when) used along with a high-nickel-based positive electrode active material and a negative electrode active material including a silicon-carbon composite. In embodiments, a silicon particle may be used to increase battery capacity, but it may cause a side reaction with an electrolyte solution, so that resistance (e.g., electrical resistance) inside the battery may be increased. Because the above-mentioned additive suppresses or reduces the side reaction of the silicon particle with the electrolyte solution, the feature of increasing battery capacity may be maximized or increased while the increase of the resistance (e.g., electrical resistance) inside the battery may be minimized or reduced.

The electrolyte solution may be prepared through a mixed process in which a lithium salt is dissolved in a non-aqueous organic solvent, and the additive is added thereto. A mixing process of the electrolyte solution may be suitably or appropriately selected from any suitable ones generally available in the art of preparing electrolyte solutions and used by those skilled in the art.

The non-aqueous organic solvent may include at least one selected from the group consisting of ethyl methyl carbonate (EMC), ethylene carbonate (EC), dimethyl carbonate (DMC), propylene carbonate (PC), propylpropionate (PP), diethyl carbonate (DEC), dipropyl carbonate (DPC), methylpropyl carbonate (MPC), ethylpropyl carbonate (EPC), methylethyl carbonate (MEC), and butylene carbonate (BC).

For example, the non-aqueous organic solvent may be a mixed solvent of ethyl methyl carbonate (EMC), ethylene carbonate (EC), and dimethyl carbonate (DMC).

For example, the ethyl methyl carbonate (EMC) may be included in an amount of about 5 vol % to about 30 vol % with respect to the total amount of the non-aqueous organic solvent. The ethylene carbonate (EC) may be included in an amount of about 10 vol % to about 30 vol % with respect to the total amount of the non-aqueous organic solvent. The dimethyl carbonate (DMC) may be included in an amount of about 50 vol % to about 80 vol % with respect to the total amount of the non-aqueous organic solvent.

The lithium salt may include at least one selected from the group consisting of LiPF₆, LiCIO₄, LiBF₄, lithium bis(fluorosulfonyl)imide (LiFSI), lithium bis(trifluoromethanesulfonyl)imide (LiTFSI), LiSO₃CF₃, LiBOB, LiFOB, LiDFBP, LiTFOP, LiPO₂F₂, LiSbF₆, LiAsF₆, LiAlO₂, LiAICl₄, LiCl, Lil, LiN(SO₃C₂F₅)₂, Li(FSO₂)₂N, and LiC₄F₉SO₃. According to an embodiment, LiPF₆ may be used as the lithium salt.

The lithium salt may have a concentration of about 0.1 M to about 3.0 M. In embodiments, the concentration of the lithium salt may be about 0.5 M or greater, or about 1.0 M or greater. The concentration of the lithium salt may be about 3.0 M or less, about 2.5 M or less, or about 2.0 M or less. According to an embodiment of the present disclosure, if (e.g., when) the concentration of the lithium salt is about 0.1 M to about 2.0 M, conductivity (e.g., ionic and/or electrical conductivity) and viscosity of the electrolyte solution may be suitably or appropriately maintained.

According to another embodiment of the present disclosure, a rechargeable lithium battery may include a positive electrode including a positive electrode active material; a negative electrode including a negative electrode active material; and an electrolyte solution, and the electrolyte solution may include a non-aqueous organic solvent; a lithium salt; and the additive represented by Formula 1 according to embodiments of the present disclosure.

The rechargeable lithium battery may be applied to automobiles, mobile phones, and/or various suitable types (or kinds) of electric devices, and an embodiment of the present disclosure is not limited thereto.

The positive electrode active material may include a lithium composite oxide represented by Formula 2 below.

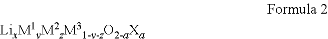

In Formula 2 above,
0.5≤x≤1.8, 0≤a≤0.05, 0≤y≤1, 0≤z≤1, and 0≤y+z≤1 may be satisfied,
M¹, M² and M³ may each independently include at least one element selected from among metal such as Ni, Co, Mn, Al, B, Ba, Ca, Ce, Cr, Fe, Mo, Nb, Si, Sr, Mg, Ti, V, W, Zr, or La, and a combination thereof.

X may include at least one element selected from among F, S, P, or C1.

In an embodiment, in Formula 2 above, M¹ may be Ni, and 0.8≤y≤1 and 0≤z≤0.2 may be satisfied. In an embodiment, in Formula 2 above, M¹ may be Ni, M² may be Co, and M³ may be Al. In an embodiment, in Formula 2 above, M¹ may be Ni, M² may be Co, and M³ may be Mn.

In an embodiment, the positive electrode active material of the rechargeable lithium battery may include nickel, cobalt, and aluminum. In an embodiment, the positive electrode active material of the rechargeable lithium battery may include nickel, cobalt, and manganese.

In the rechargeable lithium battery using the electrolyte solution according to an embodiment of the present disclosure, a carbon-based negative electrode active material, a Si-based negative electrode active material, a Sn-based negative electrode active material, or a combination thereof may be used as the negative electrode active material.

In an embodiment, the Si-based negative electrode active material may be a silicon-carbon composite. The Si-based negative electrode active material may include a core including a silicon-based particle, and a coating layer including amorphous carbon. The silicon-based particle may include at least one of a silicon particle, a Si—C composite, SiOx (0<x≤2), or a Si alloy.

If (e.g., when) the positive electrode includes a high-nickel-based positive electrode active material and the negative electrode includes a silicon-carbon composite, effects of improving high-temperature stability of the rechargeable lithium battery may be maximized or increased. The rechargeable lithium battery having the above combination may operate even at a high voltage of about 4.2 V or greater.

Hereinafter, examples and comparative examples of the present disclosure are described. However, the following examples are provided for illustrative purposes only and are not to be construed to limit the scope of the present disclosure.

### EXAMPLE AND COMPARATIVE EXAMPLE

### Example 1

### (1) Preparation of Electrolyte Solution

LiPF₆ of 1.5 M was dissolved in a non-aqueous organic solvent in which ethylene carbonate (EC), ethyl methyl carbonate (EMC), and dimethyl carbonate (DMC) were mixed in a volume ratio of about 20:10:70, and 0.25 wt % of an additive (based on 100 wt % of the electrolyte solution) was added to prepare an electrolyte solution.

A material represented by Formula 1-1 below was used as the additive.

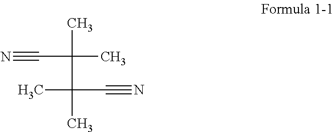

### (2) Preparation of Rechargeable Lithium Battery

97 wt % of NCA (LiNi_{0.91}Co_{0.08}Al_{0.01}O₂) as a positive electrode active material, 0.5 wt % of artificial graphite powder and 0.8 wt % of carbon black (ketjen black) as a conductive material, 0.2 wt % of acrylonitrile rubber, 1.5 wt % of polyvinylidene fluoride (PVdF) were mixed and added to N-methyl-2-pyrrolidone, and then agitated for about 30 minutes using a mechanical agitator to prepare a positive electrode active material slurry (the wt % being based on 100 wt % of the positive electrode active material slurry). A doctor blade was used to apply the slurry to a thickness of about 60 μm onto an aluminum current collector having a thickness of about 20 μm, the applied slurry was dried in a hot-air drier at about 100° C. for about 0.5 hours, then dried again for about 4 hours at about 120° C. in a vacuum condition, and roll-pressed to prepare a positive electrode.

98 wt % of a negative electrode active material in which graphite and a Si composite were mixed in a weight ratio of about 95.8:4.2, 1 wt % of styrene-butadiene rubber (SBR), and 1 wt % of carboxymethyl cellulose (CMC) were mixed and added to distilled water, and agitated for about 60 minutes using a mechanical agitator to prepare a negative electrode active material slurry (the wt % being based on 100 wt % of the negative electrode active material slurry). A doctor blade was used to apply the slurry to a thickness of about 60 μm onto a copper current collector having a thickness of about 10 μm, the applied slurry was dried in a hot-air drier at about 100° C. for about 0.5 hours, then dried again for about 4 hours at about 120° C. in a vacuum condition, and roll-pressed to prepare a negative electrode.

The positive electrode, the negative electrode, and a polyethylene separator having a thickness of about 16 μm were assembled to prepare an electrode assembly, and the electrolyte solution was introduced to prepare a rechargeable lithium battery.

### Example 2

An electrolyte solution and a rechargeable lithium battery were prepared in substantially the same manner as that of Example 1 except that 2.0 wt % of an additive was applied.

### Example 3

An electrolyte solution and a rechargeable lithium battery were prepared in substantially the same manner as that of Example 1 except that 5.0 wt % of an additive was applied.

### Example 4

An electrolyte solution and a rechargeable lithium battery were prepared in substantially the same manner as that of Example 1 except that an additive represented by Formula 1-2 below, instead of the additive represented by Formula 1-1 above, was used.

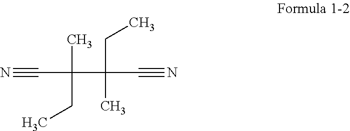

### Example 5

An electrolyte solution and a rechargeable lithium battery were prepared in substantially the same manner as that of Example 1 except that an additive represented by Formula 1-3 below, instead of the additive represented by Formula 1-1 above, was used.

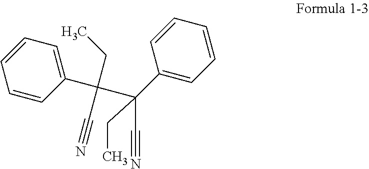 [SMILES: CCC(C#N)(c1ccccc1)C(C#N)(CC)c1ccccc1]

### Example 6

An electrolyte solution and a rechargeable lithium battery were prepared in substantially the same manner as that of Example 1 except that an additive represented by Formula 1A-4 below, instead of the additive represented by Formula 1-above, was used.

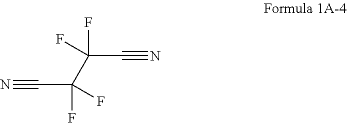

### Comparative Example 1

An electrolyte solution and a rechargeable lithium battery were prepared in substantially the same manner as that of Example 1 except that the compound represented by Formula 1-1 above was not used in the preparation of the electrolyte solution.

### Comparative Example 2

An electrolyte solution and a rechargeable lithium battery were prepared in substantially the same manner as that of Example 1 except that an additive represented by Formula 3-1 below, instead of the additive represented by Formula 1-1 above, was used.

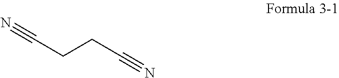

### Comparative Example 3

An electrolyte solution and a rechargeable lithium battery were prepared in substantially the same manner as that of Example 1 except that an additive represented by Formula 3-2 below, instead of the additive represented by Formula 1-1 above, was used.

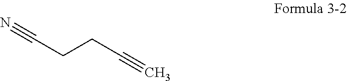

### Comparative Example 4

An electrolyte solution and a rechargeable lithium battery were prepared in substantially the same manner as that of Example 1 except that an additive represented by Formula 3-3 below, instead of the additive represented by Formula 1-1 above, was used.

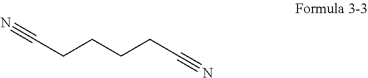

### Comparative Example 5

An electrolyte solution and a rechargeable lithium battery were prepared in substantially the same manner as that of Example 1 except that an additive represented by Formula 3-4 below, instead of the additive represented by Formula 1-1 above, was used.

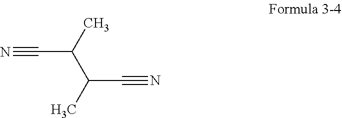

### Evaluation Example

A rechargeable lithium battery was evaluated according to the following methods.

### Evaluation 1: ICP-OES Analysis (Evaluation on Transition Metal Elution)

A formation process and charging and discharging were performed on the rechargeable lithium batteries according to the examples and comparative examples, and the rechargeable lithium batteries were stored at about 60° C. for 1 day, and then an elution amount of metal ions (Ni) was measured according to the following method. The charging and discharging were performed at about 45° C. under the condition of charge with 1.0 C (CC/CV, 4.25 V cut-off)/discharge with 1.0 C (CC, 2.5 V cut-off).

The rechargeable lithium battery was disassembled, and a positive electrode plate was separated. Thereafter, the separated positive electrode plate was placed in a 10 ml Teflon container with an electrolyte solution and the container was sealed, and then ICP-OES analysis was conducted to measure an amount of Ni, and the results are listed in Table 1 below.

### Evaluation 2: XRD Results of Positive Electrode

A formation process and charging and discharging were performed on the rechargeable lithium batteries prepared according to the examples and comparative examples, and the rechargeable lithium batteries were stored at a high temperature of about 60° C. for 30 days, and then disassembled to separate a positive electrode plate. The charging and discharging were performed at about 45° C. under the condition of charge with 1.0 C (CC/CV, 4.25 V cut-off)/discharge with 1.0 C (CC, 2.5 V cut-off).

Thereafter, an X-ray diffraction (XRD) analysis was conducted on the separated positive electrode plate to measure a peak ratio of (I₀₀₃)/(I₁₀₄), and the results are listed in Table 1 below.

### Evaluation 3: Evaluation on High-Temperature Storage Characteristics

A formation process and charging and discharging were performed on the rechargeable lithium batteries according to the examples and comparative examples, and the rechargeable lithium batteries were stored at about 60° C. for 1 day/30 days, then discharge capacities were measured and capacity retention rates were calculated, and the results are listed in Table 1 below.

The charging and discharging were performed at about 45° C. under the condition of charge with 1.0 C (CC/CV, 4.25 V cut-off)/discharge with 1.0 C (CC, 2.5 V cut-off).

The capacity retention rate was calculated according to Equation 1 and Equation 2 below.

$$Discharge capacity retention rate ( \% ) immediately after high - temperature storage = ( discharge capacity after high - temperature storage for 1 day / initial discharge capacity ) \times 100 \qquad Equation 1$$

$$Equation 2$$

$$Discharge capacity retention rate ( \% ) after high - temperature lifespan = ( discharge capacity after high - temperature lifespan of 30 days / initial discharge capacity ) \times 100$$

TABLE 1

| | | | Discharge | |
|---|---|---|---|---|
| | | | capacity | Discharge |
| | Elution | | retention rate | capacity |
| | amount of | Positive | immediately | retention rate |
| | transition | electrode | after high- | after high- |
| | metal (Co) | XRD result | temperature | temperature |
| | (ppm) | I_{[003]}/I_{[104]} | storage (%) | lifespan (%) |
| Comparative | 12.3 | 0.613 | 64.4 | 42.1 |
| Example 1 | | | | |
| Comparative | 4.9 | 0.647 | 76.1 | 46.4 |
| Example 2 | | | | |
| Comparative | 2.7 | 0.718 | 78.3 | 61.1 |
| Example 3 | | | | |
| Comparative | 2.3 | 0.724 | 76.2 | 63.2 |
| Example 4 | | | | |
| Comparative | 4.8 | 0.668 | 76.0 | 46.3 |
| Example 5 | | | | |
| Example 1 | 0.3 | 0.724 | 76.2 | 63.2 |
| Example 2 | 0.3 | 0.715 | 76.0 | 63.0 |
| Example 3 | 0.4 | 0.698 | 75.5 | 62.7 |
| Example 4 | 0.2 | 0.706 | 75.8 | 62.9 |
| Example 5 | 1.0 | 0.686 | 74.1 | 61.5 |
| Example 6 | 0.8 | 0.711 | 75.9 | 63.1 |

### Comprehensive Evaluation

Referring to Table 1 above, it can be seen that high-temperature (about 60° C.) storage characteristics were improved when using the electrolyte solutions in which the additive according to an embodiment of the present disclosure was added (Examples 1 to 6), compared with when using the electrolyte solution in which the additive according to an embodiment of the present disclosure was not added (Comparative Example 1).

Furthermore, it can be seen that the nitrile-based additive in which R₁ to R₄ functional groups in Formula 1, as described herein, were entirely substituted (Example 1) exhibited more excellent high-temperature (about 60° C.) storage characteristics than the nitrile-based additive in which R₁ to R₄ functional groups were only partially substituted (Comparative Example 5).

Referring to Table 1, it can be seen that the rechargeable lithium batteries prepared according to the examples have an elution amount of Ni in an electrode plate significantly lower than the rechargeable lithium batteries prepared according to the comparative examples. Therefore, the rechargeable lithium batteries according to the examples may have the effect on suppressing or reducing positive electrode deterioration by suppressing or reducing transition metal elution during high-temperature storage.

Referring to the peak ratio of (I₀₀₃)/(I₁₀₄) in Table 1, it can be seen that in the rechargeable lithium batteries prepared according to the examples, compared with those prepared according to the comparative examples, structural deterioration was suppressed or reduced through strong charge neutrality on the surface of the positive electrode and the suppression or reduction of transition metal elution.

An electrolyte solution for a rechargeable lithium battery according to an embodiment may suppress or reduce transition metal elution in a positive electrode and form a stable positive electrode film, thereby having the effect of improving high-temperature lifespan characteristics and stability.

Although embodiments of the present disclosure have been described with reference to the accompanying drawings, it is understood that the present disclosure should not be limited to these embodiments but various suitable changes and modifications can be made within the scope of the claims and equivalents thereof, the detailed description of the present disclosure, and the accompanying drawings, and this also falls within the scope of the present disclosure.

What is claimed is:

1. An electrolyte solution for a rechargeable lithium battery comprising:
a non-aqueous organic solvent;
a lithium salt; and
an additive represented by Formula 1 below: 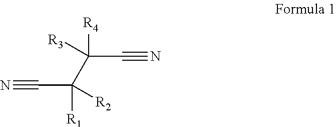
wherein, in Formula 1 above,
R₁ to R₄ are each independently selected from the group consisting of a halogen atom, a C1 to C20 alkyl group, a C1 to C20 halogenated alkyl group, a C3 to C30 cycloalkyl group, a C6 to C30 aryl group, a hydroxy group, a C1 to C10 alkoxy group, a carboxylic acid group, an aldehyde group, an epoxy group, a cyano group, a nitro group, an amino group, a sulfonic acid group, and a derivative thereof.

2. The electrolyte solution as claimed in claim 1, wherein the additive is represented by one selected from among Formula 1-1 to Formula 1-3 below: Formula 1-1

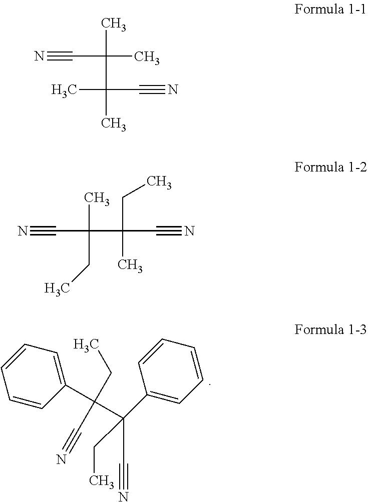

3. The electrolyte solution as claimed in claim 1, wherein, in Formula 1 above, at least one among R₁ to R₄ is a substituent containing fluorine or a fluorine atom.

4. The electrolyte solution as claimed in claim 1, wherein the additive is represented by one selected from Formula 1A-1 to Formula 1A-4 below: 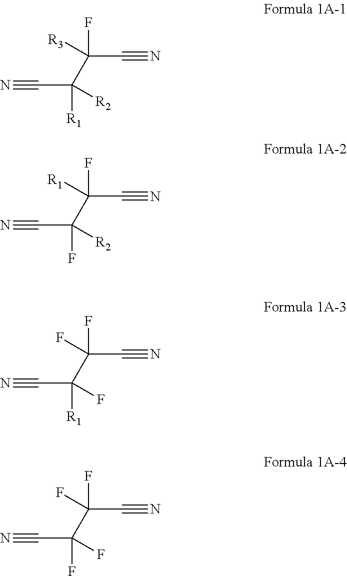
wherein, in Formula 1A-1 to Formula 1A-4 above,
R₁ to R₃ are each independently selected from the group consisting of a C2 to C20 alkyl group, a C1 to C20 alkyl group, a C1 to C20 halogenated alkyl group, a C3 to C30 cycloalkyl group, a C6 to C30 aryl group, a hydroxy group, a C1 to C10 alkoxy group, a carboxylic acid group, an aldehyde group, an epoxy group, a cyano group, a nitro group, an amino group, a sulfonic acid group, and a derivative thereof.

5. The electrolyte solution as claimed in claim 1, wherein the additive is included at about 0.01 wt % to about 10 wt % on the basis of a total weight of the electrolyte solution.

6. The electrolyte solution as claimed in claim 1, wherein the non-aqueous organic solvent comprises at least one selected from the group consisting of ethyl methyl carbonate (EMC), ethylene carbonate (EC), dimethyl carbonate (DMC), propylene carbonate (PC), propylpropionate (PP), diethyl carbonate (DEC), dipropyl carbonate (DPC), methylpropyl carbonate (MPC), ethylpropyl carbonate (EPC), methylethyl carbonate (MEC), and butylene carbonate (BC).

7. The electrolyte solution as claimed in claim 1, wherein the lithium salt is at least one selected from the group consisting of LiPF₆, LiCIO₄, LiBF₄, lithium bis(fluorosulfonyl)imide (LiFSI), lithium bis(trifluoromethanesulfonyl)imide (LiTFSI), LiSO₃CF₃, LiBOB, LiFOB, LiDFBP, LiTFOP, LiPO₂F₂, LiSbF₆, LiAsF₆, LiAlO₂, LiAlC₄, LiCl, Lil, LiN(SO₃C₂F₅)₂, Li(FSO₂)₂N, and LiC₄F₉SO₃.

8. The electrolyte solution as claimed in claim 1, wherein the lithium salt has a concentration of about 0.1 M to about 3.0 M.

9. A rechargeable lithium battery comprising:
a positive electrode comprising a positive electrode active material;
a negative electrode comprising a negative electrode active material; and
the electrolyte solution for the rechargeable lithium battery as claimed in claim 1.

10. The rechargeable lithium battery of claim 9, wherein the positive electrode active material comprises a lithium composite oxide represented by Formula below: 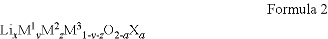
where, in Formula 2 above, 0.5≤x≤1.8, 0≤a≤0.05, 0<y≤1, 0≤z≤1, and 0≤y+z≤1,
M¹, M², and M³ each independently comprises at least one element selected from among metal comprising Ni, Co, Mn, Al, B, Ba, Ca, Ce, Cr, Fe, Mo, Nb, Si, Sr, Mg, Ti, V, W, Zr, or La, and a combination thereof, and
X comprises at least one element selected from among F, S, P, or Cl.

11. The rechargeable lithium battery as claimed in claim 10, wherein in Formula 2 above,
M¹ is Ni, 0.8≤y≤1, and 0≤z≤0.2.

12. The rechargeable lithium battery as claimed in claim 9, wherein the negative electrode active material comprises a carbon-based negative electrode active material, a Si-based negative electrode active material, a Sn-based negative electrode active material, or a combination thereof.

13. The rechargeable lithium battery as claimed in claim 12, wherein the Si-based negative electrode active material is a silicon-carbon composite.

14. The rechargeable lithium battery of claim 9, wherein the rechargeable lithium battery operates even at a high voltage of about 4.2 V or greater.
